(19) United States
(12) Patent Application Publication
(10) Pub. No.: US 2024/0312137 A1
(43) Pub. Date: Sep. 19, 2024

(54) Method and System for Modeling Region of Interest in a Geographical Location Using Cloud Data

(71) Applicant: Arka Energy Inc., Union City, CA (US)

(72) Inventors: Shreyash Singh Thakur, Hyderabad Telangana (IN); Utkarsh Singh Thakur, Jabalpur Madhya Pradesh (IN)

(21) Appl. No.: 18/606,500

(22) Filed: Mar. 15, 2024

(30) Foreign Application Priority Data
Mar. 15, 2023 (IN) 202311017519

(51) Int. Cl. G06T 17/05; G06T 7/60; G06V 10/25; G06V 10/44; G06V 10/764; G06V 10/94

(52) U.S. Cl. CPC G06T 17/05; G06T 7/60; G06V 10/25; G06V 10/44; G06V 10/764; G06V 10/95; G06T 2207/10028

(57) ABSTRACT

Embodiments of present disclosure relate to a system (100) and a method (400) for modeling a region of interest in a geographical location using point cloud data. The system (100) includes a processor (108) configured to determine, a set of planes involved in the ROI from a point cloud data using a RANSAC mechanism, and classify the received set of planes into a set of wall planes and a set of face planes. Additionally, the processor (108) may be configured to determine a set of outer edges of the ROI by using intersection of the set of wall planes and the set of face planes, and compute a set of individual facet geometries for each of the set of outer edges. Further, the processor (108) generate a 3D model of the ROI by merging the computed set of individual facet geometries.

### CROSS-REFERENCE TO RELATED APPLICATION

This application claims priority to and the benefit of Indian patent Application No. 202311017519 filed on Mar. 15, 2023, which is hereby incorporated by reference herein in its entirety.

### TECHNICAL FIELD

The present disclosure, in general, relates to structure modeling. More particularly, it relates to a method and system for modeling a region of interest in a geographical location using point cloud data.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

For a wide range of applications, it is becoming more crucial to accurately and quickly identify and represent things from digital photographs. Modeling roofs of structures is a crucial aspect of building construction and maintenance. It helps in creating accurate digital representations of building structures, which can be used for various purposes such as virtual tours, building inspections, architectural design, defining materials, and related costs for both newly-constructed buildings as well as for rebuilding and improving older structures.

Existing system recognises a collection of 2D segments and produce a 3D model of a structure. These systems may, however, have limitations, such as incapacity to recognise internal line segments or appropriately depict elevation. An incomplete or erroneous 3D model of the structure could arise from this. As a result, it is also powerful to be able to create a precise and comprehensive 3D model from 2D photos. Other existing Existing methods of modeling an area in a geographical location involve manual measurements and use of 2D drawings. However, these methods are time-consuming and prone to errors. With advent of advanced technologies like laser scanning and photogrammetry, there is now a more efficient way of modeling roofs using point cloud data.

There is, therefore, a need to overcome the above drawback, limitations, and shortcomings associated with the existing modeling techniques by providing a solution to generate accurate 3D modeling using point cloud data.

### Objects of the Present Disclosure

Some of the objects of the present disclosure, which at least one embodiment herein satisfy are as listed herein below.

A general object of present disclosure is to overcome the above drawback, limitations, and shortcomings associated with the existing modeling technique by providing a solution to automate process of modeling a region of interest in a geographical location using point cloud data.

Another object of the present disclosure is to provide a system and method for providing highly detailed and accurate representation of a geographical location.

Another object of the present disclosure is to provide a system and method to enable users to visualize a region of interest in 3D.

Another object of the present disclosure is to provide a system and method that provides a visual representation of data, making it easier for service providers to make informed decisions.

Another object of the present disclosure is to provide a system and method that automate process of modeling a region of interest, thus increasing productivity of service providers and reducing the time required to complete the task.

### SUMMARY

Various aspects of present disclosure relates to geospatial modeling. More particularly, it relates to method and system for modeling a region of interest in a geographical location using point cloud data. The proposed method and system provide highly detailed and accurate representation of a geographical location and enable users to visualize a region of interest in 3D.

An aspect of present disclosure pertains to a method for generating a 3D model of a region of interest (ROI) in a geographical area. The method may include steps of determining by a processor, a set of planes involved in the ROI from a point cloud data (i.e.e received from any of a LIDAR data and aerial photogrammetry data) using a Random Sample Consensus (RANSAC) mechanism, where the point cloud data may be stored on a server, classifying the received set of planes into a set of wall planes and a set of face planes, and further determining a set of outer edges of the ROI by using intersection of the set of wall planes and the set of face planes. Additionally, the method may include computing by the processor, a set of individual facet geometries for each of the set of outer edges by evaluating change in shape of contour of the set of individual facet geometries at one or more pre-defined heights and generating a 3D model of the ROI by merging the computed set of individual facet geometries.

In an aspect, the processor may be configured to to evaluating a set of inner edges, a set of peaks, and a set of valleys by using intersection of the set of wall planes and the set of face planes.

In an aspect, the processor may be configured to classify the received set of planes based on at least one angle of each of the set of planes with a horizontal.

In an aspect, the method of evaluating change in shape of the contour at the one or more pre-defined heights, comprises the steps of noting and storing at least one event in a stack, upon detection of any changes in the shape in tilt of the contour, assigning a set of faces corresponding to the noted at least one event, creating a half-edge data structure by connecting points corresponding to the noted at least one event and computing the set of individual facet geometries by traversing the half-edge data structure in a counterclockwise direction.

According to another aspect of present disclosure, a system to generate a 3D model of a region of interest is disclosed. The system may include a processor configured to determine a set of planes involved in the ROI from a point cloud data using a Random Sample Consensus (RANSAC) mechanism, where the point cloud data is stored on a server, and classify the received set of planes into a set of wall planes and a set of face planes. The processor may also determine a set of outer edges of the ROI by using intersection of the set of wall planes and the set of face planes, compute a set of individual facet geometries for each of the set of outer edges, wherein the set of individual facet geometries are evaluated from change in shape of contour of the set of individual facet geometries at one or more pre-defined heights, and correspondingly generate a 3D model of the ROI, where the computed set of individual facet geometries are merged to generate the 3D model. Further, the processor displays the generated 3D model on a computing device.

Various objects, features, aspects, and advantages of the present disclosure will become more apparent from the following detailed description of preferred embodiments, along with the accompanying drawing figures in which like numerals represent like features.

### BRIEF DESCRIPTION OF THE ACCOMPANYING DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a block diagram of a system to model a region of interest in a geographical location using point cloud data, in accordance with an embodiment of the present disclosure.

FIG. 2 illustrates exemplary functional components of a processing engine of the system, in accordance with an embodiment of the present disclosure.

FIG. 3 illustrates a flow chart of a process for modeling a region of interest in a geographical location using point cloud data, in accordance with an embodiment of the present disclosure.

FIG. 4 illustrates an exemplary computer system to implement proposed system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims. Embodiments of present disclosure relates to geospatial modeling. More particularly, it relates to method and system for modeling a region of interest in a geographical location using point cloud data.

An embodiment of present disclosure pertains to a method for generating a 3D model of a region of interest (ROI) in a geographical area. The method may include steps of determining by a processor, a set of planes involved in the ROI from a point cloud data (i.e.e received from any of a LIDAR data and aerial photogrammetry data) using a Random Sample Consensus (RANSAC) mechanism, where the point cloud data may be stored on a server, classifying the received set of planes into a set of wall planes and a set of face planes, and further determining a set of outer edges of the ROI by using intersection of the set of wall planes and the set of face planes. Additionally, the method may include computing by the processor, a set of individual facet geometries for each of the set of outer edges by evaluating change in shape of contour of the set of individual facet geometries at one or more pre-defined heights, and generating a 3D model of the ROI by merging the computed set of individual facet geometries.

In an embodiment, the processor may be configured to to evaluating a set of inner edges, a set of peaks, and a set of valleys by using intersection of the set of wall planes and the set of face planes.

In an embodiment, the processor may be configured to classify the received set of planes based on at least one angle of each of the set of planes with a horizontal.

In an embodiment, the method of evaluating change in shape of the contour at the one or more pre-defined heights, comprises the steps of noting and storing at least one event in a stack, upon detection of any changes in the shape in tilt of the contour, assigning a set of faces corresponding to the noted at least one event, creating a half-edge data structure by connecting points corresponding to the noted at least one event and computing the set of individual facet geometries by traversing the half-edge data structure in a counterclockwise direction.

According to another embodiment of present disclosure, a system to generate a 3D model of a region of interest is disclosed. The system may include a processor configured to determine a set of planes involved in the ROI from a point cloud data using a Random Sample Consensus (RANSAC) mechanism, where the point cloud data is stored on a server, and classify the received set of planes into a set of wall planes and a set of face planes. The processor may also determine a set of outer edges of the ROI by using intersection of the set of wall planes and the set of face planes, compute a set of individual facet geometries for each of the set of outer edges, wherein the set of individual facet geometries are evaluated from change in shape of contour of the set of individual facet geometries at one or more pre-defined heights, and correspondingly generate a 3D model of the ROI, where the computed set of individual facet geometries are merged to generate the 3D model. Further, the processor displays the generated 3D model on a computing device.

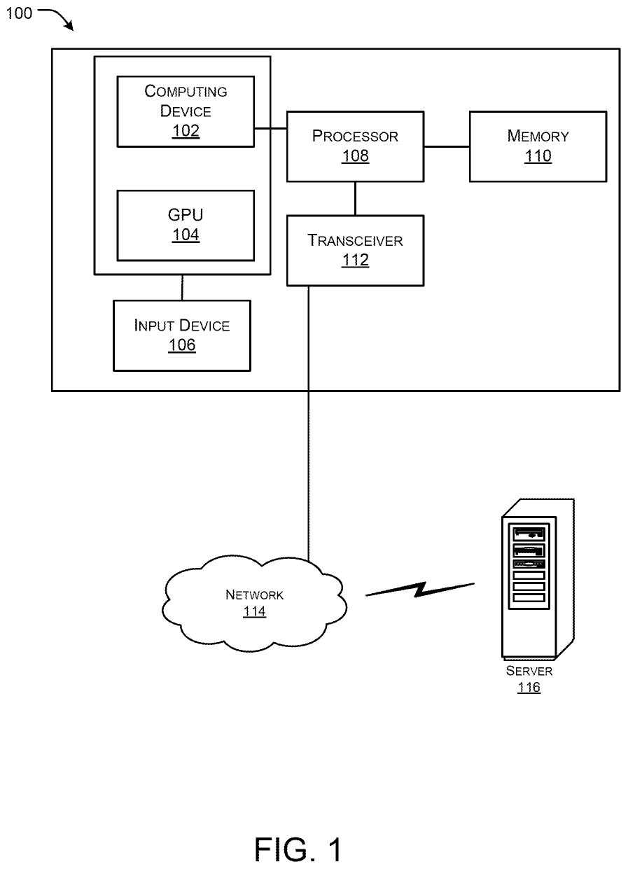

FIG. 1 illustrates a block diagram of a system to model a region of interest in a geographical location using point cloud data, in accordance with an embodiment of the present disclosure.

As illustrated, a system 100 to model a region of interest (ROI) in a geographical location is disclosed. The geographical area can be a city that includes both buildings and terrain. The ROI can be roof of any structure such as the building. As used herein, “building” means any manmade structure such as houses, office buildings, storage tanks, warehouses, sports arenas, or the like. The system 100 includes a computing device 102 having a graphical processing unit (GPU) 104, and the computing device 102 can be operatively coupled to an input device 106. The computing device 102 may correspond to various types of computing devices, such as, but not limited to, a desktop computer, a laptop, a PDA, a mobile device, a smartphone, a tablet computer, and the like. The input device 106 may be selected from a group consisting of a mouse, keyboard, a joystick, or the like. The graphical processing unit (GPU) 104 acts as a processing unit for all graphical user interfaces (GUI) in the computing device. In an exemplary embodiment, the GPU 104 renders graphics data inside the GUI and ensures that graphical data is displayed to the computing device 102. In addition, the GPU can be used for memory-intensive tasks like rendering images and videos, animations, and CAD tasks.

In an embodiment, the system 100 includes a processor 108 that can be communicatively coupled to the computing device 102, a memory 110, and a transceiver 112. The processor 108 includes suitable logic, circuitry, and/or interfaces that are operable to execute one or more instructions stored in the memory 110 to perform pre-determined operation of the system. The memory 110 may be operable to store the one or more instructions. The processor 108 may be implemented using one or more processor technologies known in the art. Examples of the processor 108 include but are not limited to, an x86 processor, a RISC processor, an ASIC processor, a CISC processor, an Arduino Uno board, an ESP 8266 node microcontroller, or any other processor. The memory 110 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 110 includes the one or more instructions that are executable by the processor 108 to perform specific operations. It will be apparent to a person having ordinary skill in the art that the one or more instructions stored in the memory 110 enable multiple components of the system 100 to perform predetermined operations.

In an embodiment, the transceiver 112 transmits and receives messages and data to/from various components of the system 100. Examples of the transceiver 112 may include, but are not limited to, an antenna, an Ethernet port, an USB port or any other port that can be configured to receive and transmit data. The transceiver 112 transmits and receives data/messages in accordance with various communication protocols, such as, TCP/IP, UDP, and 2G, 3G, or 4G communication protocols.

In an embodiment, a point of data may be stored on a server 116, the point of data may include such as but not limited to LIDAR data and aerial photogrammetry data. The server can be communicatively coupled to the processor through a network 114. The network 114 corresponds to a medium through which content and messages flow between various devices of the system 100 (e.g., computing device 102, the server 116). Examples of the network 114 may include, but are not limited to, a Wireless Fidelity (Wi-Fi) network, a Wide Area Network (WAN), a Local Area Network (LAN), or a Metropolitan Area Network (MAN). Various devices in the system 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

In an embodiment, the server 116 may receive a query from the computing device 102 for retrieving various point cloud data stored in the server 116. For querying the server 116, one or more querying languages may be utilized such as, but not limited to, SQL, QUEL, DMX and so forth. Further, the server 116 may be realized through various technologies such as, but not limited to, Microsoft® SQL server, Oracle, and My SQL. In an embodiment, the server 116 may connect to the computing device 102 using one or more protocols such as, but not limited to, ODBC protocol and JDBC protocol.

In an embodiment, the processor 108 may be configured to receive the point cloud data stored on the server through the network 114, and determine a set of planes involved in the ROI using a Random Sample Consensus (RANSAC) mechanism. In an exemplary embodiment, during iteration process, RANSAC mechanism is performed many times, and corresponding data set is removed from the point cloud data. The next iteration continues on the remaining points. Finally, iteration is terminated when the number of non-modelled points is smaller than defined threshold. An essential advantage of RANSAC mechanism is that number of trials and data size are not directly dependent on each other. Thus, iterations can be quickly obtained on even high-density point cloud data.

In an exemplary embodiment, while applying of RANSAC mechanism on the received point cloud data, largest roof plane in the point cloud data is detected and then this area is removed from the original point cloud data. In the next iteration step, the second largest roof plane can be detected. So, in each step, the detected roof plane must be removed in order to find other roof planes, and the set of planes is determined.

In an embodiment, the processor 108 is configured to classify, the received set of planes based on at least one angle of each of the set of planes with a horizontal, where identified vertical planes are classified as a set of wall planes and identified non-vertical planes planes are classified as a set of face planes. Additionally, the processor 108 computes a set of individual facet geometries for each of the set of outer edges by evaluating change in shape of contour of the set of individual facet geometries at one or more pre-defined heights. The processor 108 may also be configured to evaluate a set of inner edges, a set of peaks, and a set of valleys by using intersection of the set of wall planes and the set of face planes. Further, the processor generates a 3D model of the ROI by merging the computed set of individual facet geometries.

In an exemplary embodiment, visualization indicative of plurality of solar panels attached to roof of the generated 3D model may be downloaded from the computing device. Also, components required while selecting at least one of the roof model can be evaluated. The components may be solar panel, inverter, DC disconnect, AC disconnect, meter, wire, charge controller, battery, junction box, combiner box, circuit breaker, fuse, load center, rapid shutdown, surge device, or the like. Further based on the required components cost of solar installation on the roof may be evaluated and displayed to the GUI of the computing device. This enable the service provider to provide exemplary 3D models, components requirement, and cost prior to installing the solar panels to customers. Further, based on customers' requirement, cost or other factors, 3D models and components may be updated easily by the proposed system.

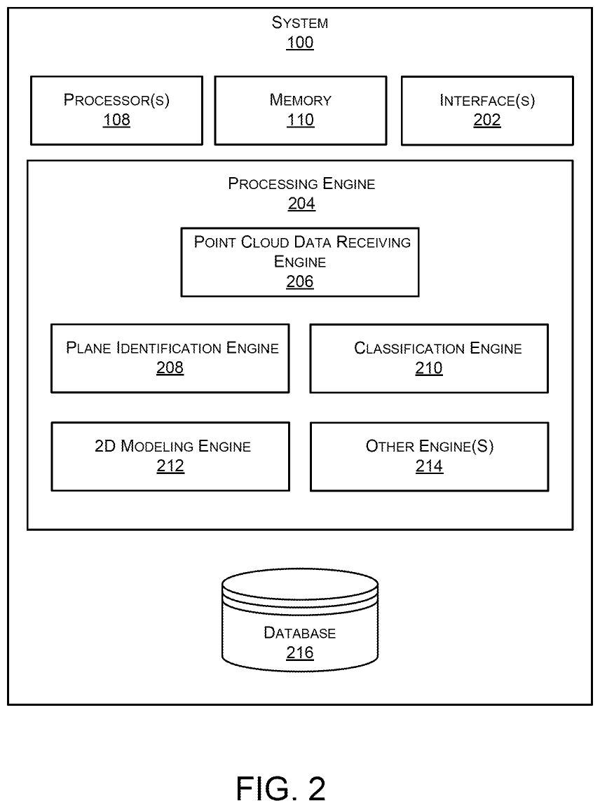

FIG. 2 illustrates exemplary functional components of a processing engine of the system, in accordance with an embodiment of the present disclosure.

In an embodiment, a system 100 includes a processor 108, a memory 110, and one or more interface(s) 202. The interface 202 may include a variety of interfaces, for example, interfaces for data input and output devices, referred to as I/O devices, storage devices, and the like. The interface 202 may also provide a communication pathway for one or more components of system 100. Examples of such components include, but are not limited to, a processing engine 204 and a database 216.

The processing engine 204 is provided with the processor 108, and it can be implemented as a combination of hardware and programming (for example, programmable instructions) to implement one or more functionalities of the processing engine 204. In examples described herein, such combinations of hardware and programming may be implemented in several different ways. For example, the programming for the processing engine 204 may be processing unit executable instructions stored on a non-transitory machine-readable storage medium, and the hardware for the processing engine 204 may include a processing resource (for example, one or more processors), to execute such instructions. In the present examples, the machine-readable storage medium may store instructions that, when executed by the processing resource, implement the processing engine 204. In such examples, the processing engine 204 can include the machine-readable storage medium storing the instructions and the processing resource to execute the instructions, or the machine-readable storage medium may be separate but accessible to the processor 108 and the processing resource. In other examples, the processing engine 204 can be implemented by electronic circuitry.

In an embodiment, the processing engine 204 includes a point cloud data receiving engine 206, a plane identification engine 208, a classification engine 210, a 3D modeling engine 212, and other engine(s) 214. The other engine(s) 214 can implement functionalities that supplement applications or functions performed by system 100 or the processing engine 204. It would be appreciated that the modules being described are only exemplary modules and any other modules or sub-modules may be included as part of system 100. These units too may be merged or divided into super-modules or sub-modules as may be configured. In addition, database 216 includes data that is either stored or generated as a result of functionalities implemented by any of the components of system 100.

In an embodiment, the point cloud data receiving engine 206 may be configured to receive a point cloud data from a server 116. The point cloud data can be LIDAR data and aerial photogrammetry data. In an exemplary embodiment, LiDAR data may have been previously acquired by aerial surveyors, and the received LiDAR data is raw data which has not been processed to isolate points corresponding to the building of interest. Accordingly, the received LiDAR data includes data points corresponding to not only the building, but to surrounding objects, such as vegetation, ground, and other buildings.

In an embodiment, the plane identification engine 208 may be configured to determine, a set of planes involved in the ROI from a point cloud data using a Random Sample Consensus (RANSAC) mechanism, wherein the point cloud data is stored on a server

In an embodiment, the classification engine 210 may be configured to classify the received set of planes into a set of wall planes and a set of face planes and determine a set of outer edges of the ROI by using intersection of the set of wall planes and the set of face planes. Also, evaluates a set of inner edges, a set of peaks, and a set of valleys by using intersection of the set of wall planes and the set of face planes. Further, the classification engine 210 computing a set of individual facet geometries for each of the set of outer edges by evaluating change in shape of contour of the set of individual facet geometries at one or more pre-defined heights.

Additionally, the classification engine 210 may be configured to evaluate change in shape of the contour at the one or more pre-defined heights by noting and storing, at least one event in a stack, upon detection of any changes in the shape in tilt of the contour. Further, assign a set of faces corresponding to the noted at least one event, create a half-edge data structure by connecting points corresponding to the noted at least one event, and compute the set of individual facet geometries by traversing the half-edge data structure in a counterclockwise direction.

In an embodiment, 3D modeling engine 212 may be configured to generate a 3D model of the ROI by merging the computed set of individual facet geometries.

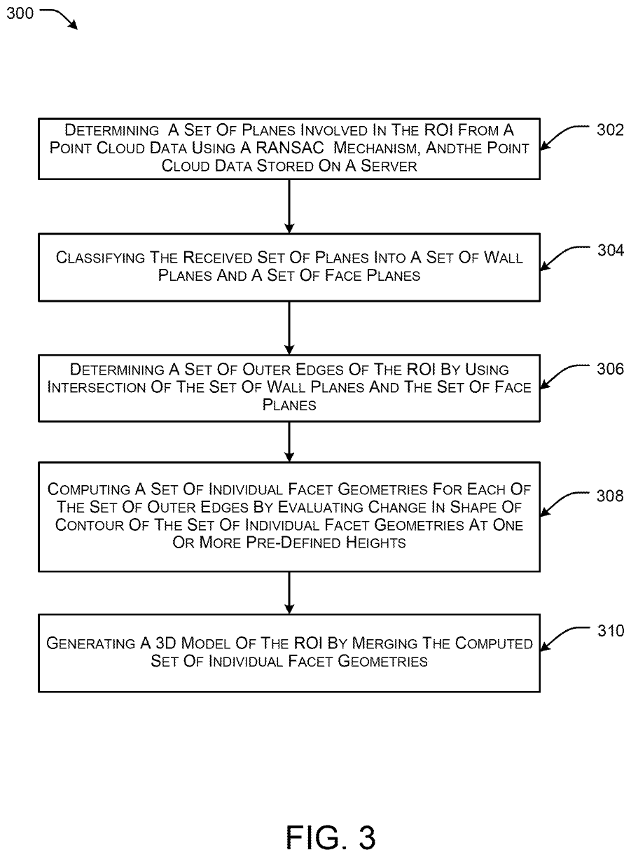

FIG. 3 illustrates a flow chart of a process for modeling a region of interest in a geographical location using point cloud data, in accordance with an embodiment of the present disclosure.

As illustrated, at block 302, a method 300 includes determining, by a processor, a set of planes involved in the ROI from a point cloud data using a Random Sample Consensus (RANSAC) mechanism, wherein the point cloud data is stored on a server. In an exemplary embodiment, the point cloud data may be processed and denoised, and RANSAC mechanism may be applied to compute obtain all planes in the data.

As illustrated, at block 304, the method 300 includes classifying by the processor, the received set of planes into a set of wall planes and a set of face planes. In an exemplary embodiment, each plane may be classified based on angle made with horizontal, where vertical planes may be classified as walls and non-vertical planes as face planes.

As illustrated, at block 306, the method 300 includes determining by the processor, a set of outer edges of the ROI by using intersection of the set of wall planes and the set of face planes.

As illustrated, at block 308, the method 300 includes computing by the processor, a set of individual facet geometries for each of the set of outer edges by evaluating change in shape of contour of the set of individual facet geometries at one or more pre-defined heights. Additionally, the method 300 of evaluating change in shape of the contour at the one or more pre-defined heights, noting and storing, at least one event in a stack, upon detection of any changes in the shape in tilt of the contour, and assigning a set of faces corresponding to the noted at least one event. Further, creating a half-edge data structure by connecting points corresponding to the noted at least one event, and computing the set of individual facet geometries by traversing the half-edge data structure in a counterclockwise direction.

In an exemplary embodiment, pairwise intersection of each wall plane and each face plane may be performed, and intersection lines of these planes are evaluated to generate the outline polygon of the entire roof and facet may be created using the pair of planes and the edge. Also, the point cloud data may be used to compute the contour of the roof at a given height. This represents the horizontal cross-section of the roof and it may be evaluated at each possible height where three plane intersections occur from the original set of planes. Further, if shape of contour changes or there is a sharp change in the tilt of any contour edge the event is noted and pushed to a stack. Each event may be assigned a set of faces based on which original planes they lie on, and a half-edge data structure may be created by connecting the points corresponding to the events based on them sharing a pair of faces.

As illustrated, at block 310, the method 300 includes generating, by the processor, a 3D model of the ROI by merging the computed set of individual facet geometries. The individual facet geometries may be computed by traversing the half-edge in a counterclockwise fashion to generate final roof by drawing all the walls and face geometries.

In an exemplary embodiment, extract all planes in the point cloud data and classify them, use wall planes and face planes to calculate outline polygon edges, use 3-Plane intersections to determine inner edges, peaks, and valleys, and calculate individual face geometries and combine them for the final roof structure.

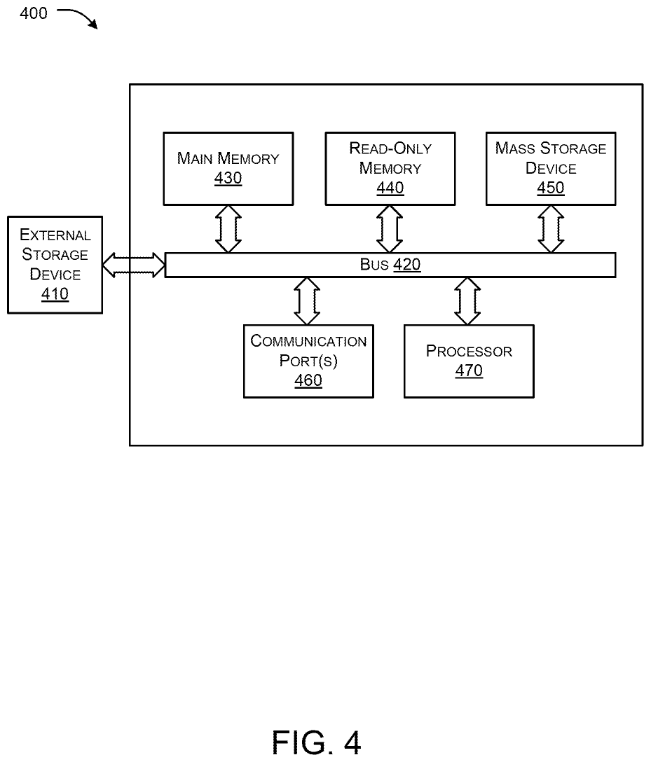

FIG. 4 illustrates an exemplary computer system to implement proposed system, in accordance with an embodiment of the present disclosure. As shown in FIG. 4, a computer system 400 can include an external storage device 410, a bus 420, a main memory 430, a read only memory 440, a mass storage device 450, communication port 460, and a processor 470. A person skilled in the art will appreciate that the computer system may include more than one processor and communication ports. Examples of processor 470 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 470 may include various modules associated with embodiments of the present invention. Communication port 460 can be any of an RS-232 port for use with a modem-based dialup connection, a 10/100 Ethernet port, a Gigabit or 10 Gigabit port using copper or fibre, a serial port, a parallel port, or other existing or future ports. Communication port 460 may be chosen depending on a network, such a Local Area Network (LAN), Wide Area Network (WAN), or any network to which computer system connects. Memory 430 can be Random Access Memory (RAM), or any other dynamic storage device commonly known in the art. Read-only memory 440 can be any static storage device(s) e.g., but not limited to, a Programmable Read Only Memory (PROM) chips for storing static information e.g., start-up or BIOS instructions for processor 470. Mass storage 450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 420 communicatively couples processor(s) 470 with the other memory, storage, and communication blocks. Bus 420 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system.

Optionally, operator and administrative interfaces, e.g., a display, keyboard, and a cursor control device, may also be coupled to bus 420 to support direct operator interaction with a computer system. Other operator and administrative interfaces can be provided through network connections connected through communication port 460. The external storage device 410 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Embodiments disclosed herein provide system and method to provide highly detailed and accurate representation of a geographical location and enable users to visualize a region of interest in 3D.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced.

Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to those having ordinary skill in the art.

### Advantages of the Invention

The present disclosure provides a system and method to automate process of modeling a region of interest in a geographical location using point cloud data.

The present disclosure provides a system and method to provide highly detailed and accurate representation of a geographical location.

The present disclosure provides a system and method to provide to enable users to visualize a region of interest in 3D.

The present disclosure provides a system and method to provide a visual representation of data, making it easier for service providers to make informed decisions.

The present disclosure provides a system and method to automate process of modeling a region of interest, thus increasing productivity of service providers and reducing the time required to complete the task.

We claim:

1. A method for generating a 3D model of a region of interest (ROI) in a geographical area, the method comprising:
determining, by a processor, a set of planes involved in the ROI from a point cloud data using a Random Sample Consensus (RANSAC) mechanism, wherein the point cloud data is stored on a server;
classifying, by the processor, the received set of planes into a set of wall planes and a set of face planes;
determining, by the processor, a set of outer edges of the ROI by using intersection of the set of wall planes and the set of face planes;
computing, by the processor, a set of individual facet geometries for each of the set of outer edges by evaluating change in shape of contour of the set of individual facet geometries at one or more pre-defined heights; and
generating, by the processor, a 3D model of the ROI by merging the computed set of individual facet geometries.

2. The method as claimed in claim 1, wherein the point cloud data comprises any of a LIDAR data and aerial photogrammetry data.

3. The method as claimed in claim 1, wherein the processor is communicatively coupled to the sever by a network.

4. The method as claimed in claim 1, wherein the processor is configured to evaluating a set of inner edges, a set of peaks, and a set of valleys by using intersection of the set of wall planes and the set of face planes.

5. The method as claimed in claim 1, wherein the processor is configured to classify the received set of planes based on at least one angle of each of the set of planes with a horizontal.

6. The method as claimed in claim 1, wherein the method of evaluating change in shape of the contour at the one or more pre-defined heights, comprises the steps of:
noting and storing, at least one event in a stack, upon detection of any changes in the shape in tilt of the contour;
assigning, a set of faces corresponding to the noted at least one event;
creating, a half-edge data structure by connecting points corresponding to the noted at least one event; and
computing, the set of individual facet geometries by traversing the half-edge data structure in a counterclockwise direction.

7. A system to generate a 3D model of a region of interest, the system comprising:
a processor; and
a memory storing instructions that, when executed by the processor, cause the processor to perform:
determine, a set of planes involved in the ROI from a point cloud data using a Random Sample Consensus (RANSAC) mechanism, wherein the point cloud data is stored on a server;
classify, the received set of planes into a set of wall planes and a set of face planes;
determine, a set of outer edges of the ROI by using intersection of the set of wall planes and the set of face planes;
compute, a set of individual facet geometries for each of the set of outer edges, wherein the set of individual facet geometries are evaluated from change in shape of contour of the set of individual facet geometries at one or more pre-defined heights;
generate, a 3D model of the ROI, wherein the computed set of individual facet geometries are merged to generate the 3D model; and
display, the generated 3D model on a computing device.

8. The system as claimed in claim 7, wherein the point cloud data comprises any of a LIDAR data and aerial photogrammetry data.

9. The system as claimed in claim 7, wherein the processor is configured to evaluate a set of inner edges, a set of peaks, and a set of valleys by using intersection of the set of wall planes and the set of face planes.

10. The system as claimed in claim 7, wherein the processor is configured to classify the received set of planes based on at least one angle of each of the set of planes with a horizontal.
